(19) United States
(12) Patent Application Publication
(10) Pub. No.: US 2012/0155070 A1
(43) Pub. Date: Jun. 21, 2012

(54) PIR INDUCTIVE LED LAMP TUBE

(76) Inventors: Ming-Yun CHEN, Dongguan (CN); Zuo-Tsai Hong, Dongguan (CN)

(21) Appl. No.: 12/973,943

(22) Filed: Dec. 21, 2010

(51) Int. Cl. F21V 1/00

(52) U.S. Cl. 362/217.02

(57) ABSTRACT

An IP processing technology, and more particularly to a human infrared recipient processor, which comprising: an amplifying circuit, a switch control circuit for output of switching signals, a PIR for obtaining human IR signals, a PHOT for obtaining brightness signals, a main controller IC1 used for A/D conversion and digital filtering of human IR signals and logical control/output of high-/low-level signals by the brightness and switching signals, as well as an external output circuit for controlling the working states depending on high-/low-level signals; said main controller IC1 is a SD7823, the human infrared recipient processor of the present invention features simple construction, higher SNR, stability and sensitivity as well as stronger logical functions.

### BACKGROUND OF INVENTION

1. Field of the Invention

The present invention relates generally to a lamp tube, and more particularly to a Passive Infrared sensor (PIR) inductive LED lamp tube.

2. Description of Related Art

Lamps are widely applied to lightings of urban roads, courtyards, corridors, garages, offices and public occasions, etc, for the benefit of the users. The commonly used lamps include: tungsten lamps, fluorescent lamps and LED lamps, of which LED lamps are most commonly used due to the advantages such as high efficiency, safety, energy-saving, environmental protection, long service life and quick response.

LED lamp tube is a common LED lighting that permits to control the on/off state of LED lamp bulbs by the switch, but it is inconveniently operated unsuitable for auto-control occasions.

### CONTENT OF THE INVENTION

The objective of the present invention is to provide a PIR inductive LED lamp tube that can be conveniently operated suitable for auto-control occasions.

### SUMMARY OF THE INVENTION

The present invention can be implemented through the following technology schemes: a PIR inductive LED lamp tube, which comprises a lamp shade, lamp holder, LED lamp and lamp tube, of which the lamp holder is set at both ends of the lamp tube, the lamp shade is set onto the lamp tube to cover said LED lamp; it also comprises a PIR sensor, which is set onto said lamp shade.

Said lamp tube is an aluminum alloy radiator.

Radiating fin is set onto the external wall of said aluminum alloy radiator.

Said lamp shade is a semi-spherical tube.

Said lamp shade is a PVC tube shield.

The efficacies of present invention include: said PIR inductive LED lamp tube comprises: a lamp shade, lamp holder, LED lamp and lamp tube, of which the lamp holder is set at both ends of the lamp tube, the lamp shade is set onto the lamp tube to cover said LED lamp; it also comprises a PIR sensor, which is set onto said lamp shade. When the temperature of human body is sensed by PIR sensor, LED lamp is highlighted; otherwise LED lamp is extinguished, thus realizing convenient auto-control and utilization.

### BRIEF DESCRIPTION OF THE DRAWINGS

FIG. 1: a structure diagram of the present invention.

### DETAILED DESCRIPTION OF THE INVENTION

The following is a detailed description of the present invention based on the attached drawings:

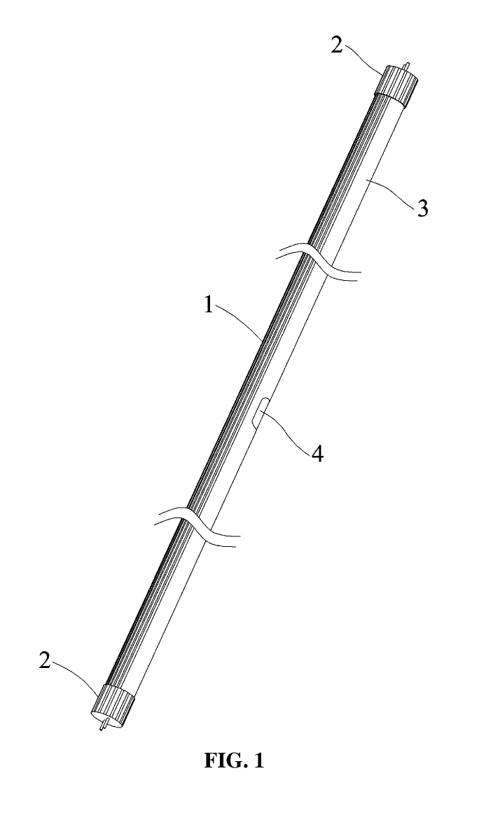

Referring to FIG. 1, the PIR inductive LED lamp tube comprises: a lamp shade 3, lamp holder 2, LED lamp and lamp tube 1, of which the lamp holder 2 is set at both ends of the lamp tube 1, the lamp shade 3 is set onto the lamp tube 1 to cover said LED lamp; it also comprises a PIR sensor 4, which is set onto said lamp shade. As a preferred embodiment, said lamp tube 1 is an aluminum alloy radiator; radiating fin is set onto the external wall of said aluminum alloy radiator, which features excellent heat conductivity and dissipation effect; the radiating fin can increase the contact area of the aluminum alloy radiator with external air, and improve the heat dissipation effect of the aluminum alloy radiator. As a preferred embodiment, said lamp shade 3 is a semi-spherical tube and also a PVC tube shield.

The operating principle of said PIR inductive LED lamp tube of the present invention is that: when the temperature of human body is sensed by PIR sensor 4, LED lamp is highlighted; otherwise LED lamp is extinguished, thus realizing convenient auto-control. If switches are used collaboratively, it can be used more flexibly and conveniently in auto-control occasions.

The above is a detailed description of the technical features of the utility model based on a typical preferred embodiment. However, it should be appreciated that the present invention is capable of a variety of embodiments and various modifications by those skilled in the art, and all such equivalent variations or changes shall be embraced within the scope of the following claims.

1. A PIR inductive LED lamp tube, which comprising: a lamp shade, lamp holder, LED lamp and lamp tube, of which the lamp holder is set at both ends of the lamp tube, the lamp shade is set onto the lamp tube to cover said LED lamp. It is characterized by that, it also comprises a PIR sensor, which is set onto said lamp shade.

2. The PIR inductive LED lamp tube as claimed in claim 1, wherein it is characterized by that: said lamp tube is an aluminum alloy radiator.

3. The PIR inductive LED lamp tube as claimed in claim 2, wherein it is characterized by that: radiating fin is set onto the external wall of said aluminum alloy radiator.

4. The PIR inductive LED lamp tube as claimed in claim 3, wherein it is characterized by that: said lamp shade is a semi-spherical tube.

5. The PIR inductive LED lamp tube as claimed in claim 4, wherein it is characterized by that: said lamp shade is a PVC tube shield.
